(19) United States
(12) Patent Application Publication
(10) Pub. No.: US 2014/0263433 A1
(43) Pub. Date: Sep. 18, 2014

(54) Beverage Dispense System and Method

(71) Applicant: HEINEKEN UK LIMITED, Edinburgh (GB)

(72) Inventors: Chris Merrifield, Harpenden (GB); Stuart Briant, Nottingham (GB); Simon Gray, Nottingham (GB)

(21) Appl. No.: 13/835,179

(22) Filed: Mar. 15, 2013

(51) Int. Cl. B67D 1/08

(52) U.S. Cl. CPC B67D 1/0857; B67D 1/0878
USPC 222/66; 62/389; 222/146.6; 137/455; 29/428; 285/93; 285/41

(57) ABSTRACT

The present invention relates to beverage dispense systems and methods. The systems comprise a beverage line having a distal end connectable to a beverage supply for transporting beverage from the beverage supply to a dispense font at a dispensing site. They also include a cooler for cooling beverage. The beverage line comprises a first beverage line portion extending from the distal end to the cooler within a first insulated carrier. The first insulated carrier comprises a first cooling line for transporting cooling medium through the first insulated carrier so as to allow heat exchange between the cooling medium in the first cooling line and the beverage in the first beverage line portion.

The present invention relates to beverage dispense systems and methods. In particular, the present invention relates to beverage dispense systems and methods for dispensing beverages such as lager or cider at a low temperature.

### BACKGROUND

Many beverages including beers, lagers and ciders are beneficially served at low temperatures. If the temperature of the beverage is too high, the quality and the taste of the beverage may be impaired. In addition, recent consumer trends have increased the demand for beverages to be served at a lower temperature, for example, below 3° C. In order to meet consumer expectations, it is desirable to dispense beverages at a consistent low temperature.

Systems are known for dispensing draught beverages. By “draught beverages” is meant beverages which are stored at a point remote from the point of dispensing and transferred on demand to the point of dispensing through a beverage line. Typically the transfer is achieved using a pumping mechanism. For instance, it is common in public houses and bars for beverages to be stored in a cooled cellar or a storage room (typically cooled to a temperature of around 12° C. using a cooling unit) and transferred to the bar area where dispensing occurs at a font using a mechanical pump or a pressurised gas system.

The length of the beverage line between the cellar/storage room and the dispensing site may be many metres (e.g. up to 30 m) and there is a tendency for beverage in the beverage lines to increase in temperature during transit. In an attempt to address this problem, it is known to provide a cooler in or near the cellar/storage room to cool the beverage and then to transport the beverage to the dispensing site inside an insulated and cooled conduit known as a “python”. The cooler typically comprises an ice bank and a water bath, the water in the water bath being cooled by the ice bank. The beverage line passes from the cellar/storage room through the water bath and beverage contained in the beverage line is thus cooled. The cooled beverage then flows through the python to the dispensing site, the python also carrying a cooling circuit through which cold water from the water bath is circulated. It is also known to use a glycol cooling medium in the cooler and cooling circuit to effect even greater cooling for beverages which are intended to be served “extra cold”.

Draught beverages such as lagers and ciders are typically stored within storage kegs inside the cooled cellar/storage room. The beverage line portion extending between a storage keg and the cooler typically passes through a fob detector having a float within a chamber. When the storage keg is empty, the float sinks to the base of the chamber and seals off the beverage line. The user is then required to leave the dispensing site and proceed to the cellar/storage room to disconnect the empty storage keg from the beverage line and connect a new storage keg. The change over between storage kegs typically requires bleeding of the beverage from a valve at the top of the fob detector in order to raise the float within the chamber.

The present inventors have identified a number of problems associated with known beverage systems.

Many draught beverages such as lagers and ciders are pasteurised and hermetically sealed within the storage kegs. Accordingly, until the seal on the storage keg is breached by attachment of a keg coupler (for connection to the beverage line and pressurised gas system) to the top of the storage keg, the beverage inside the storage keg is sterile. Once breached, any microorganisms, e.g. yeasts, within the dispense system can gain access to and spoil the beverage inside the storage keg. Most microorganisms enter the known dispense systems through the tap on the font at the dispensing site and work their way back through the beverage line to the storage keg. The spoiling of the beverage reduces its quality and impairs its taste which may result in increased waste if it becomes necessary to discard spoiled beverage. Weekly cleaning of the beverage line is recommended in order to minimise the presence of microorganisms in the dispense system. Line cleaning is a time consuming task that inevitably leads to some waste of beverage and can lead to a considerable waste of beverage if it is carried out inexpertly (which is often the case).

The inventors have found that a temperature of 12° C. (i.e. the typical temperature of the cellar/storage room and thus the typical temperature of the beverage in the storage keg, fob detector and beverage line portion extending between the storage keg and the cooler) is a temperature at which proliferation of microorganisms typically found in beverage systems occurs. Accordingly, once the storage keg is breached, microorganism growth within the storage keg, fob detector and beverage line portion extending between the storage keg and the cooler may be prolific.

Cooling the cellar/storage room to a lower temperature in an attempt to reduce microorganism growth is not ideal because of the extra energy that this will consume and also because many public houses/bars also store cask ales in their cellar/storage room and the quality of these cask ales will be impaired by lower temperatures.

Further wastage of beverage occurs through use of the known fob detectors. As discussed above, bleeding of beverage through valve at the top of the fob detector is required during change over to a new, full storage keg. A significant amount of beverage is wasted by being bled from valve. Furthermore, this volume is typically drained onto the floor of the cellar/storage room which is unsightly, unhygienic (since it will be prone to microorganism growth) and a potential slipping hazard.

The present invention aims to reduce microorganism growth within a beverage dispense system and thus reduce beverage wastage.

### SUMMARY OF THE INVENTION

In a first aspect, the present invention provides a beverage dispense system comprising: a beverage line having a distal end connectable to a beverage supply for transporting beverage from the beverage supply to a dispense font; and a cooler for cooling beverage, the beverage line comprising a first beverage line portion extending from the distal end to the cooler within a first insulated carrier, the first insulated carrier comprising a first cooling line for transporting cooling medium through the first insulated carrier so as to allow heat exchange between the cooling medium in the first cooling line and the beverage in the first beverage line portion.

In known beverage dispense systems only the portion of beverage line carrying beverage from the cooler to the dispense font at the dispensing site is contained within an insulated carried such as a python. By providing an insulated carrier containing a cooling line carrying cooling medium for the first beverage line portion extending from the beverage supply (e.g. storage keg) to the cooler (i.e. by enclosing the entire first beverage line portion within a cooled insulated carrier), it is possible to commence cooling of the beverage as soon as it leaves the beverage supply (storage keg). As a result, microorganism growth in the line is significantly reduced because the beverage within this portion of beverage line is no longer at a temperature that encourages microorganism growth. This helps slow the passage of microorganisms towards the beverage in the storage keg which helps reduce spoilage, and therefore waste, of the beverage. The reduction in microorganism growth resulting from cooling of the beverage line between the beverage supply and the cooler has allowed line cleaning to be carried out much less frequently e.g. every 4 weeks. This, in turn, further reduces beverage wastage and also requires considerably less time and effort from the user.

The present inventors have also found that cooling the beverage line portion between the storage keg and cooler reduces microorganism growth sufficiently such that it is no longer necessary to store the beverage supply in a chilled cellar/storage room. The beverage supply e.g. storage keg can be stored at any desired location e.g. in an un-chilled cellar/storage room or even at the dispensing site if space allows. This removal of the requirement to chill the cellar/storage room reduces energy expenditure considerably.

In preferred embodiments, the beverage line further comprises a second beverage line portion for transporting beverage from the cooler to the dispense font at the dispensing site through a second insulated carrier, the second insulated carrier comprising a second cooling line for transporting cooling medium through the second insulated carrier so as to allow heat exchange between the cooling medium in the second cooling line and the beverage in the second beverage line portion.

This ensures that beverage chilled in the cooler remains at the desired low temperature (e.g. between 1 and 5° C.) right up to point of dispense.

Preferably, the cooler is adapted to generate cooling medium for transportation within the first and/or second cooling line. The cooler typically comprises an ice bank and a cooling medium reservoir, the cooling medium in the cooling medium reservoir being cooled by the ice bank.

By using a cooler that both cools the beverage and generates the cooling medium for transportation in the cooling line(s), energy savings can be made. However, it is envisaged that the cooler could be a flash cooler and the system could comprise a separate cooling medium generator to generate cooling medium for transportation within the cooling line(s).

The beverage line preferably includes a cooling beverage line portion that passes through the cooling medium reservoir in the cooler from the first beverage line portion to the second beverage line portion. Preferably, the cooling beverage line portion is a coiled portion that can be immersed in the cooling medium in the reservoir. The amount of coil immersed can be varied to determine the extent of heat exchange and hence the extent of cooling of the beverage.

The first cooling line preferably forms part of a first cooling circuit, the first cooling circuit including the first cooling line extending from the cooler or the cooling medium generator through the first insulated carrier to the beverage supply and a first return line extending from the beverage supply through the first insulated carrier to the cooling medium reservoir or generator. The first cooling line and first return line typically have a diameter of between 9.5 mm and 15 mm.

At least a portion of the first insulated carrier is preferably of the type known as a “python” which comprises a tubular sleeve formed of insulating plastics material. The first cooling line and the first return line preferably pass through the first python close to its axial centre with the first beverage line portion running co-axially with the first cooling/return lines.

The second cooling line preferably forms part of a second cooling circuit, the second cooling circuit including the second cooling line extending from the cooler or the cooling medium generator through the second insulated carrier to the dispensing site and a second return line extending from the dispensing site through the second insulated carrier to the cooling medium reservoir or generator. The second cooling line and second return line typically have a diameter of 15 mm.

The second cooling circuit preferably includes a font cooling circuit for carrying cooling medium into the dispense font to allow heat exchange with the second beverage line portion 10 within the font to maintain the low temperature of the beverage and, optionally, to promote formation of condensation on the outer surface of the font (for aesthetic reasons). The lines in the font cooling circuit typically have a diameter of around 9.5 mm (⅜ inch).

The system preferably includes a second insulated carrier of the type known as a “python” which comprises a tubular sleeve formed of insulating plastics material. The length of second insulated carrier is unlimited but, typically, will be between 3 and 30 metres. A length of around 30 metres is most typical.

The second cooling line and the second return line preferably pass through the second insulated carrier (python) close to its axial centre with one or more second beverage line portions running co-axially with the second cooling/return lines.

The cooler is preferably a remote cooler i.e. it is remote from the dispensing site.

As discussed above, the beverage may be transferred from the beverage supply to the dispensing site using a pressurized gas system. In preferred embodiments, the beverage dispense system of the first aspect comprises a gas line connectable to a gas supply wherein the gas supply line is at least partly enclosed within the first insulated carrier. By bundling the gas line together with the first beverage line portion and the first cooling circuit, the beverage dispense system can be kept neat and clean with minimal exposed lines.

Preferred embodiments of the beverage dispense system comprise a manifold through which the first beverage line portion passes. The manifold comprises an insulated core e.g. a foam core which forms part of the first insulated carrier. For example, the first insulated carrier may comprise a distal first insulated carrier portion (e.g. a python-type carrier) between the distal end of the first beverage line portion and the manifold, the manifold, and a proximal first insulated carrier portion (e.g. a further python-type carrier) between the manifold and the cooler.

In preferred embodiments, the beverage dispense system is for dispensing a plurality of beverages. In these embodiments, the beverage dispense system comprises a plurality of beverage lines each having a respective distal end connectable to a respective beverage supply for transporting beverage from the respective beverage supply to a respective dispense font at the dispensing site. Each beverage line comprises a respective first beverage line portion extending from the respective distal end to the cooler. Each beverage line portion may extend to the cooler within a respective first insulated carrier i.e. the system comprises a plurality of first insulated carriers, each first insulated carrier comprising a respective first cooling line in heat exchange relationship with the respective first beverage line portion.

More preferably, the beverage dispense system comprises a manifold and each beverage line portion extends from its distal end to the manifold in a respective distal first insulated carrier portion (preferably of the python-type) but thereafter, up to the cooler, the beverage lines are bundled together in the insulating core of the manifold and then in a single proximal first insulated carrier portion (preferably a further python-type insulated carrier) from the manifold to the cooler.

Preferably, the beverage system is for dispensing two or four beverages and thus comprises two or four beverage lines each within its own distal first insulated carrier portion. In these embodiments (especially in the embodiments for dispensing only two beverages), the beverage supply (i.e. storage kegs) can be stored at the dispensing site.

In other preferred embodiments, the beverage system is for dispensing eight or ten beverages and thus comprises eight or ten beverage lines each within its own distal first insulated carrier portion.

In these embodiments for dispensing a plurality of beverages, all of the second beverage line portions for transporting beverage from the cooler to the dispensing site are preferably bundled together within a single second insulated carrier, all of the second beverage line portions being in heat exchange relationship with the second cooling line.

In preferred embodiments, the length of the first beverage line portion between the distal end and the manifold is selected such that, when the manifold is mounted on the wall or ceiling of the beverage supply site (i.e. where the beverage supply is stored), the distal end of the beverage line does not contact the floor of the beverage supply site.

This helps avoid contamination of the beverage line during replacement of the beverage supply.

As discussed above, known dispense system include fob detectors typically comprising a reservoir of beverage within a chamber, the beverage sitting at the ambient temperature of the cellar i.e. around 12° C. This provides a reservoir in which microorganism growth can occur. The present invention preferably avoids the use of traditional fob detectors.

In a second aspect, the present invention provides connector for use in a beverage dispense system for connecting a beverage line to a beverage supply, the connector comprising a sensor for sensing bubbles within the beverage line and for generating a signal for closing the beverage line when a predetermined level of bubbles is detected.

Bubbles within a beverage can be an early indication that fobbing is about to commence and thus that the beverage supply is nearly depleted (i.e. the storage keg is nearly empty). By providing a sensor which sends a signal e.g. to a valve such as a solenoid valve, when a predetermined level of bubbles (which predetermined level may be as low as a single bubble) is detected in the beverage line, the use of traditional fob detectors (and the associated problems therewith) can be avoided.

The connector may be directly connectable to the beverage supply but, preferably, the connector is connectable e.g. by a push- or screw-fit to a standard keg coupler (i.e. a coupler which connects to the top of the keg spear and which has a gas line inlet and a beverage outlet).

The sensor may be an optical sensor having an optical transmitter and an optical receiver. A suitable sensor is described in GB2236180, the contents of which are incorporated herein by reference.

Preferably, the beverage line has a distal end (proximal the beverage supply and remote from the point of dispense) and the connector is affixed at the distal end of the beverage line (with the beverage line passing through the connector).

By providing the sensor in a connector at the distal end of the beverage line, the sensor can be positioned as close to the beverage supply as possible such that the bubbles preceding fobbing (which is indicative of the impending emptying of the storage keg) can be detected at the earliest possible moment.

Preferably, the connector contains cooling means for cooling the beverage line within the connector. In this way (unlike traditional fob detectors), any beverage can be maintained at temperature at which microorganism growth is limited.

The cooling means may comprise a connector cooling circuit comprising a connector cooling line and a connector cooling return line for carrying chilled cooling medium, the cooling lines being in heat exchange relationship with the beverage line.

In preferred embodiments, the connector further comprises an indicator for providing an indication when the sensor has generated a signal for closing the beverage line. The indicator is preferably a visible indicator e.g. a light, which may come on, go out or change color when the beverage line is closed.

The indicator is useful especially in beverage dispense systems where there are a plurality of beverage supplies each with a connector. In this case, the indicators identify to the user which beverage supply is depleted and which storage keg requires changing.

In preferred embodiments, the connector further comprises a re-set actuator e.g. button or switch which is operable to generate a signal to re-open the beverage line once the beverage supply has been replenished (i.e. the storage keg changed). In embodiments where the system includes an indicator, the re-set actuator is also preferably operable to re-set the indicator (e.g. turn the light on, off or change its color).

In most preferred embodiments, a first mode of actuation of the re-set actuator causes the beverage line to be opened to a bleed line for a predetermined amount of time thus discharging any fob in the beverage prior to reconnection of the beverage line. The first mode of actuation is preferably a single short actuation (e.g. depression) of the re-set actuator e.g. a single short depression of a button.

After a predetermined amount of time (determined from the length of the beverage line between the sensor and the valve and from the flow rate of the beverage) the valve closes the bleed line and re-establishes fluid communication along the length of the beverage line.

The amount of beverage wasted during this bleeding is significantly reduced compared to the amount wasted during bleeding of traditional fob detectors. Furthermore, the bleed line can be directed to a drain or to a container thus avoiding cellar contamination.

A second mode of actuation of the re-set actuator preferably initiates a cleaning function. The second mode of actuation is preferably a single long actuation (e.g. depression) of the re-set actuator e.g. a prolonged depression of a button but it may also be a plurality of short actuations. The second mode of actuation of the re-set actuation is only effected when a water or cleaning fluid supply is attached to the distal end of the beverage line. The second mode of actuation of the re-set actuator causes the opening of the beverage line and for the water/cleaning fluid to be pumped through the beverage line to effect cleaning. This need only be effected once every 4 weeks if the connector of the second aspect is used in the beverage dispense system of the first aspect.

Preferably, the connector of the second aspect is preferably used in a bubble detection system as described below.

In a third aspect, the present invention provides a bubble detection system for use in a beverage dispense system, the bubble detection system comprising a connector for connecting a beverage line to a beverage supply, the connector comprising a sensor for sensing bubbles within the beverage line and for generating a signal for closing the beverage line when a predetermined level of bubbles is detected, and a valve operable to close the beverage line upon receipt of the signal from the sensor.

Bubbles within a beverage can be an early indication that fobbing is about to commence and thus that the beverage supply is nearly depleted (i.e. the storage keg is nearly empty). By providing a sensor which sends a signal to a valve (e.g. a solenoid valve) when a predetermined level of bubbles (which predetermined level may be as little as a single bubble) is detected in the beverage line, the use of traditional fob detectors (and the associated problems therewith) can be avoided.

The connector is preferably as described for the second aspect.

The indicator for providing an indication when the valve is closed may be provided on the connector as discussed above. However, if the valve is remote from the connector, there may be an additional or an alternative indicator adjacent the valve. In most preferred embodiments, if the valve is remote from the connector, two indicators are provided, one on the connector and one adjacent the valve.

The indicator(s) is/are useful especially in dispense systems where there are a plurality of beverage supplies each with a respective bubble detection system. In this case, the indicators identify to the user which beverage supply is depleted and which storage keg requires changing.

The re-set actuator e.g. button or switch which is operable to re-open the valve once the beverage supply has been replenished (i.e. the storage keg changed) and/or operable to re-set the indicator(s), may be provided on the connector as discussed above or, in cases where the valve is remote from the connector, there may be an additional or alternative re-set actuator adjacent the valve.

In most preferred embodiments, a first mode of actuation of the re-set actuator causes beverage contained in the beverage line between the beverage supply and the valve to be discharged to a bleed line for a predetermined amount of time. To achieve this, the valve is preferably a two-way valve that can direct beverage from the beverage line either towards the dispensing site or to the bleed line. In this manner, upon the first mode of actuation of the re-set actuator, the valve opens to the bleed line. The first mode of actuation is preferably a single short actuation (e.g. depression) of the re-set actuator e.g. a single short depression of a button.

After a predetermined amount of time (determined from the length of the beverage line between the sensor and the valve and from the flow rate of the beverage) the valve closes the bleed line and re-establishes fluid communication along the length of the beverage line.

The amount of beverage wasted during this bleeding is significantly reduced compared to the amount wasted during bleeding of traditional fob detectors. Furthermore, the bleed line can be directed to a drain or to a container thus avoiding cellar contamination.

A second mode of actuation of the re-set actuator preferably initiates a cleaning function. The second mode of actuation is preferably a single long actuation (e.g. depression) of the re-set actuator e.g. a prolonged depression of a button but it may also be a plurality of short actuations. The second mode of actuation of the re-set actuation is only effected when a water or cleaning fluid supply is attached to the distal end of the beverage line. The second mode of actuation of the re-set actuator causes the valve to open the beverage line and for the water/cleaning fluid to be pumped through the beverage line to effect cleaning. This need only be effected once every 4 weeks if the bubble detection system of the third aspect is used in the beverage dispense system of the first aspect.

The bubble detection system preferably comprises an electronic control unit for receiving the signal from the sensor and, in response to the signal from the sensor, sending a signal to the valve to close the beverage line. The signal between the sensor and the electronic control unit may be transmitted via a wire.

In preferred embodiments, the electronic control unit also sends a signal to activate the indicator(s) upon receipt of a signal from the sensor. The signal between the electronic control unit and the indicator(s) may be transmitted via a wire.

In preferred embodiments, the electronic control unit also sends a signal to the valve to open to the bleed line upon receipt of a signal from the re-set actuator in the first mode of actuation and to reconnect the beverage line upon receipt of a signal from the re-set actuator in the second mode of actuation. It preferably also sends a signal to re-set the indicator(s) upon actuation of the re-set actuator. The signal between the re-set actuator and the electronic control unit may be transmitted via a wire.

Preferably, the bubble detection system further comprises a manifold housing the valve. When an indicator and/or re-set actuator is provided adjacent the valve, the indicator/re-set actuator is preferably mounted on or extends from within the manifold. The manifold preferably further houses the electronic control unit. Preferably, the manifold is remote from the connector e.g. it may be affixable to a wall or the ceiling of the beverage supply site (cellar/storage room). In this way, the beverage supply site can be kept clear to allow easy access to the storage kegs.

The wires between the electronic control unit and a) the sensor, b) any connector indicator and c) any connector re-set actuator will run, preferably in a bundle, from the connector to the manifold.

The manifold preferably comprises an insulating core e.g. a foam core through which the beverage lines pass. This insulating core helps maintain the temperature of the beverage as it passes through the manifold.

In a fourth aspect, the present invention provides a beverage dispense system comprising a beverage line connectable to a beverage supply for transporting beverage from the beverage supply to a dispensing site and a connector according to the second aspect.

In a fifth aspect, the present invention provides a beverage dispense system comprising a beverage line connectable to a beverage supply for transporting beverage from the beverage supply to a dispensing site and a bubble detection system according to the third aspect.

Preferably, the beverage dispense system of the fourth and fifth aspects is as described for the first aspect. In these embodiments, the bubble detection system is provided in the first beverage line portion between the beverage supply and the cooler, with the connector at the distal end of the first beverage line portion.

Preferably, the connector cooling circuit is connected to the first cooling circuit, with the connector cooling line being an extension of the first cooling line and the connector cooling return line extending to the first cooling return line.

The manifold is preferably positioned between the connector and the cooler e.g. approximately equidistant between the two. The first insulated carrier comprises a distal first insulated carrier portion extending from the connector to the manifold and a proximal first insulated carrier portion extending between the manifold and the cooler. The manifold preferably comprises an insulating core e.g. a foam core through which the beverage lines and the first cooling circuit pass. This insulating core forms part of the first insulated carrier and helps maintain the beverage at a low enough temperature to limit microorganism growth as it passes through the manifold.

Preferably, the wires between the electronic control unit and a) the sensor, b) any connector indicator, and c) any connector re-set actuator preferably run from the connector to the manifold within the distal first insulated carrier portion.

In a sixth aspect, the present invention provides a method of replacing a beverage supply in a beverage dispense system having a beverage line with a distal end connected to the beverage supply for transporting beverage from a beverage supply site to a dispensing site, the method comprising providing a connector according to the second aspect of the invention at the distal end of the beverage line, sensing a predetermined level of bubbles in the beverage line using the sensor, generating a signal to close the beverage line, detaching the connector from the beverage supply and affixing the connector to a second beverage supply.

In preferred embodiments, the method further comprises providing an indication (using one or more indicators) when the sensor has generated a signal for closing the beverage line. The indication is preferably a visible indication e.g. a light, which may come on, go out or change color when the beverage line is closed.

In preferred embodiments, the method further comprise providing a re-set actuator e.g. button or switch and actuating the re-set actuator to generate a signal to re-open the beverage line once the connector has been connected to the second beverage supply. In embodiments where the method includes providing an indication, the method preferably comprises actuating the re-set actuator to generate a signal to re-set the indicator(s).

In most preferred embodiments, the method comprises actuating the re-set actuator in a first mode to cause the beverage line to be opened to a bleed line for a predetermined amount of time for discharging any fob in the beverage. Actuating the re-set actuator in a first mode preferably comprises subjecting the re-set actuator to a single short actuation (e.g. depression) e.g. a single short depression of a button.

In most preferred embodiments, the method comprises actuating the re-set actuator in a second mode to cause the beverage line to be reconnected to allow the pumping of water/cleaning fluid through the beverage line. Actuating the re-set actuator in the second mode of actuation preferably comprises subjecting the re-set actuator to a single long actuation (e.g. depression) e.g. a prolonged depression of a button, or a plurality of short actuations

In preferred embodiments, the method comprises closing the beverage line upon receipt of the signal from the sensor using a valve e.g. a solenoid valve. Most preferably the valve is a two-way valve and the method comprises opening the beverage line to the bleed line for a predetermined amount of time using the valve upon receipt of the signal from the re-set actuator.

In most preferred embodiments, the method comprises providing an electronic control system for receiving the signal from the sensor and, in response to the signal from the sensor, sending a signal to the valve to close the beverage line.

In preferred embodiments, the electronic control unit also sends a signal to activate the indicator(s) upon receipt of a signal from the sensor.

In preferred embodiments, the electronic control unit also sends a signal to the valve to open to the bleed line for a predetermined amount of time upon receipt of a signal from the re-set actuator in the first mode of actuation and to reconnect the beverage line upon receipt of a signal from the re-set actuator in the second mode of actuation. It preferably also sends a signal to re-set the indicator(s) upon actuation of the re-set actuator.

In known beverage dispense systems, microorganisms (and dirt) can be introduced into the dispense system during change-over of the beverage supply as a result of the beverage lines contacting the floor or the cellar/storage room.

To avoid this contamination, in a seventh aspect, the present invention provides a beverage dispense system comprising: a beverage line having a distal end connectable to a beverage supply for transporting beverage from a beverage supply site to a dispensing site; the system further comprising a manifold through which the beverage line passes, wherein the length of beverage line between the distal end and the manifold is selected such that, when the manifold is mounted on the wall or ceiling of the beverage supply site, the distal end of the beverage line does not contact the floor of the beverage supply site.

By providing a manifold suspended on the wall or ceiling of the beverage supply site, with the length of the beverage line extending from the manifold to the beverage supply being selected such that the distal end of the beverage line does not contact the floor of the beverage supply site, contamination of the beverage line by microorganisms and/or dirt can be minimised.

The features of the dispense system according to the seventh aspect can be combined with the features of the first and/or fourth and/or fifth aspects with the manifold positioned between the distal end of the beverage line and the cooler.

In an eighth aspect of the present invention, there is provided a method of installing a beverage dispense system comprising: providing a beverage line having a distal end connectable to a beverage supply for transporting beverage from a beverage supply site to a dispensing site; providing a manifold through which the beverage line passes, mounting the manifold on the wall or the ceiling of the beverage supply site wherein the method further comprises selecting a length of beverage line between the distal end and the manifold such that, when the manifold is mounted on the wall or ceiling of the beverage supply site, the distal end of the beverage line does not contact the floor of the beverage supply site.

The manifold may be mounted directly onto the wall or ceiling of the beverage supply site but, preferably, the manifold is mounted onto brackets affixed to the wall or ceiling of the beverage supply site. The brackets may be such that the manifold is suspended from the ceiling.

Preferably, the method is for installing a beverage dispense system according to the first and/or fourth and/or fifth aspects of the present invention with the manifold provided between the distal end of the beverage line and the cooler.

To help increase the hygiene in the beverage supply site yet further, the present invention provides, in an ninth aspect, a cooler for cooling beverage in a beverage dispense system wherein the cooler has a casing having a slanted top surface.

By providing a slanting top surface, no horizontal surfaces are presented for the user to deposit items which may collect dust and thus reduce the cleanliness of the beverage supply site.

The cooler of the ninth aspect may be used in the dispense systems of any of the first, fourth, fifth or sixth aspects.

Preferred embodiments of the present invention will now be described with reference to the accompanying Figures in which:

FIG. 1 shows a schematic representation of a first embodiment of a beverage dispense system according to the present invention;

FIG. 2 shows an enlarged schematic representation of the manifold of the first embodiment;

FIG. 3 shows a schematic representation of a first embodiment of a connector according to the present invention;

FIG. 4 shows a schematic representation of a first embodiment of a method according to the present invention; and

FIG. 5 shows a schematic representation of a second embodiment of a beverage dispense system according to the present invention.

### DETAILED DESCRIPTION OF THE INVENTION

FIG. 1 shows a beverage dispense system 1 for dispensing two beverages.

The system comprises: two beverage lines 2, 2′ each having a distal end 3, 3′ connectable to a respective beverage supply 4, 4′ for transporting beverage from each beverage supply 4, 4′ to a dispensing site 5 having two dispense fonts 13, 13′ each with a respective tap 12, 12′ through which the beverage is dispensed.

The system further comprises a cooler 6 for cooling beverage. The cooler 6 is adapted to generate cooling medium. The cooler 6 comprises an ice bank and a cooling medium reservoir (not shown), the cooling medium in the cooling medium reservoir being cooled by the ice bank.

Each beverage line 2, 2′ comprises a first beverage line portion 7, 7′ extending from the respective distal end 3, 3′ to the cooler 6. Each first beverage line portion 7, 7′ extends within a first insulated carrier which is made up of a respective distal first insulated carrier portion 8, 8′ which is a python-type insulated carrier, a foam core 33 of a manifold 19 (see FIG. 3) and a combined proximal first insulated carrier portion which is a further python type insulated carrier 20.

A first cooling line 9 for transporting cooling medium (generated by the cooler 6) through the proximal first insulated carrier portion (a python-type insulated carrier 20), the core 33 of the manifold 19 and then through the two distal first insulated carrier portions 8, 8′ is provided so as to allow heat exchange between the cooling medium in the first cooling line 9 and the beverage in the first beverage line portions 7, 7′.

The first cooling line 9 forms part of a first cooling circuit, the first cooling circuit including the first cooling line 9 extending from the cooler 6 through the proximal first insulated carrier portion 20, the manifold 19 and distal first insulated carrier portions 8, 8′ to each beverage supply 4, 4′ and a first return line 16 returning the cooling medium to the cooling medium reservoir of the cooler 6. The first cooling line 9 and first return line 16 typically have a diameter of 9.5 mm (in the distal first insulated carrier portions) and 15 mm (within the manifold 19 and the proximal first insulated carrier portion).

The beverage lines 2, 2′ further comprise a respective second beverage line portion 10, 10′ for transporting beverage from the cooler 6 to the respective tap 12, 12′ on the respective dispense font 13, 13′ at the dispensing site 5 through a second insulated carrier 11. The second insulated carrier 11 comprises a second cooling line 14 for transporting cooling medium (from the cooler 6) through the second insulated carrier 11 so as to allow heat exchange between the cooling medium in the second cooling line 14 and the beverage in the second beverage line portions 10, 10′.

The second cooling line 14 preferably forms part of a second cooling circuit, the second cooling circuit including the second cooling line 14 extending from the cooler 6 through the second insulated carrier 11 to the dispensing site 5 and a second return line 17 extending from the dispensing site 5 through the second insulated carrier 11 to the cooling medium reservoir of the cooler 6. The second cooling line and second return line typically have a diameter of 15 mm.

The second cooling circuit also includes a font cooling circuits 42, 42′ which carry cooling medium into the font to allow heat exchange with the second beverage line portion 10 in the font to maintain the low temperature of the beverage and, optionally, to promote formation of condensation on the outer surface of the font (for aesthetic reasons). The lines in the font cooling circuit typically have a diameter of around 9.5 mm (⅜ inch).

Each beverage line 2, 2′ includes a respective cooling beverage line portion 15, 15′ that passes through the cooling medium reservoir in the cooler 6 from the first beverage line portion 7, 7′ to the respective second beverage line portion 10, 10′. Each cooling beverage line portion 15, 15′ is a coiled portion that can be immersed in the cooling medium in the reservoir. The amount of coil immersed can be varied to determine the extent of heat exchange and hence the extent of cooling of the beverage.

At the distal ends 3, 3′ of the beverage lines is provided a respective connector 18, 18′.

A connector which is connected to a standard keg coupler 22 is shown in FIG. 2.

The connector 18 includes a sensor 21 for sensing bubbles within the beverage line 2 and for generating a signal for closing the beverage line (using a solenoid valve—shown in FIG. 3) when a predetermined level of bubbles (e.g. a single bubble) is detected.

The connector has a push fit element 23 for fitting to the standard keg coupler 22 (i.e. a coupler which connects to the top of the keg spear and which has a gas line inlet 24).

The sensor is an optical sensor having an optical transmitter and an optical receiver as described in GB2236180.

The connector contains a connector cooling circuit 25 comprising a connector cooling line 29 for receiving cooling medium from the first cooling line 9 and a connector cooling return line 26 for returning cooling medium to the first cooling return line. The connector cooling medium circuit is in heat exchange relationship with the beverage line 2 within the connector for cooling the beverage as it leaves the storage keg.

The connector 18 further comprises an indicator 27 for providing an indication when the sensor 21 has generated a signal for closing the beverage line 2. The indicator 27 is a light which changes from green to red when the beverage line 2 is closed. The red light shines onto the beverage supply (storage keg) to highlight to the user which keg needs changing.

The connector further comprises a re-set actuator 28 (button) which is operable to generate a signal to re-open the beverage line 2 once the beverage supply 4 has been replenished (i.e. the storage keg changed). The re-set actuator 28 is also operable to re-set the indicator 27 i.e. to turn the red light back to green.

The re-set actuator may be operated in a first mode of actuation by a single, short depression of the button and, in the first mode of actuation, the beverage line is opened to a bleed line 32 as discussed below.

Alternatively, the re-set actuator may be operated in a second mode of actuation by a single, prolonged depression of the button. The second mode of actuation of the re-set actuation is only effected when a water or cleaning fluid supply is attached to the distal end 3, 3′ of the beverage line 2, 2′. The second mode of actuation of the re-set actuator causes the opening of the beverage line 2, 2′ and for the water/cleaning fluid to be pumped through the beverage line 2, 2′ to effect cleaning. This need only be effected once every 4 weeks.

FIG. 3 shows an enlarged view of a portion of the manifold showing the foam core 33 and the solenoid valve 30 which is operable to close the beverage line upon receipt of the signal from the sensor 21 in the connector.

The valve 30 is a two-way valve which can either direct beverage from the beverage supply 4 towards the dispensing site 5 or towards a bleed line 32 which exits the manifold 19 and is directed towards a drain or storage tank.

The manifold is provided with a further indicator 27′ for providing a further indication when the sensor 21 has generated a signal for closing the beverage line 2. The indicator 27′ is also a light which changes from green to red when the beverage line 2 is closed. The red light shines onto distal first insulated carrier portion 8.

The re-set actuator 28 is also operable to re-set the further indicator 27′ i.e. to turn the further red light back to green.

The signal is transferred from the sensor 21 to the valve 30 through a wire 35 via an electronic control unit (ECU) 31 on the manifold. In response to the signal from the sensor 21, the ECU 31 sends a signal to the solenoid valve 30 to close the beverage line and also sends a signal to the indicators 27, 27′, via a wire 36 in the case of the indicator 27 on the connector 18.

The re-set actuator button 28 is also connected to the ECU via a wire 37. Actuation of the re-set actuator button 28 sends a signal to the ECU which then sends a signal to the valve 30 to open the beverage line 2 to the bleed line 32 (in the first mode of actuation) or to reconnect the beverage line 2, 2′ to allow pumping of water/cleaning fluid (in the second mode of actuation) and also sends a signal to the indicators 27, 27′ to deactivate them.

All of the wires 35, 36 and 37 are bundled within the distal first insulated carrier portion 8.

The distal first insulated carrier portion 8 also contains a gas line 38 (shown in FIG. 2) which connectable to a gas supply at one end and connectable to the gas inlet 24 on the keg coupler 22 at its other end. The gas line exits the distal first insulated carrier portion 8 before it joins the connector 18.

FIG. 4 shows a schematic representation of first embodiment of a method for replacing a beverage supply.

Upon sensing a predetermined level of bubbles in the beverage line using the sensor 21, a signal is generated and passed along the distal first insulated carrier portion 8 through wire 35 to the ECU 31.

Upon receipt of this signal the ECU 31 sends a signal to the solenoid valve 30 causing it to close the beverage line.

The ECU 31 also sends a signal to the indicator 27′ on the manifold 19 and to the indicator 27 on the connector via wire 36 to activate the indicators i.e. to turn the lights from green to red.

A user entering the beverage supply site can immediately see which beverage supply (storage keg) requires changing by observing the indicators 27, 27′.

The user will disconnect the depleted beverage supply by removing the connector 18 from the beverage supply and will then connect the connector to a new beverage supply.

At this time, the user will depress the re-set actuator button 28 using a single, short depression which will send a signal to the ECU 31 via wire 37. The ECU 31 will send a signal to the solenoid valve 30 which will open the beverage line 2 to the bleed line 32 to discharge any fob from the line.

After a predetermined amount of time (determined from the length of the beverage line between the sensor and the valve and from the flow rate of the beverage), the valve closes the bleed line and re-establishes fluid communication along the length of the beverage line so that beverage can be transported to the dispensing site 5.

The ECU will then send a signal to the indicator 27′ on the manifold 19 and to the indicator 27 on the connector via wire to deactivate the indicators i.e. to turn the red lights back to green.

Every 4 weeks, it will be necessary effect cleaning of the beverage line 2, 2′. In this case, after disconnection of the depleted beverage supply, the user will connect a water/cleaning fluid supply to the distal end 3, 3′ of the beverage line and will actuate the re-set actuator in the second mode of actuation (by effecting a prolonged depression of the button). This will cause the valve 30 to reconnect the beverage line to allow pumping of the water/cleaning fluid through the beverage line.

FIG. 5 shows a schematic representation of a second embodiment of a beverage dispense system according to the present invention however, the features shown may also be incorporated into the first embodiment and thus the same numbering is used.

The length of beverage line 2, 2′ (enclosed within the distal first insulated carrier portion) between the distal ends 3, 3′ and the manifold 19 is selected such that, when the manifold 19 is suspended from the ceiling 38 of the beverage supply site on brackets 39, the distal ends 3, 3′ (and the connectors 18, 18′) of the beverage line do not contact the floor 40 of the beverage supply site.

The cooler 6 has a casing having a slanted top surface 41.

By providing a slanting top surface, no horizontal surfaces are presented for the user to deposit items which may collect dust and thus reduce the cleanliness of the beverage supply site.

1. A beverage dispense system comprising:
a beverage line having a distal end connectable to a beverage supply for transporting beverage from the beverage supply to a dispense font at a dispensing site; and
a cooler for cooling beverage,
the beverage line comprising a first beverage line portion extending from the distal end to the cooler within a first insulated carrier, the first insulated carrier comprising a first cooling line for transporting cooling medium through the first insulated carrier so as to allow heat exchange between the cooling medium in the first cooling line and the beverage in the first beverage line portion.

2. A beverage dispense according to claim 1 wherein the beverage line further comprises a second beverage line portion for transporting beverage from the cooler to the dispensing site through a second insulated carrier, the second insulated carrier comprising a second cooling line for transporting cooling medium through the second insulated carrier so as to allow heat exchange between the cooling medium in the second cooling line and the beverage in the second beverage line portion.

3. A beverage dispense system according to claim 1 wherein the cooler is adapted to generate cooling medium for transportation within the first and/or second cooling line.

4. A beverage dispense system according to claim 1 wherein the first cooling line forms part of a first cooling circuit, the first cooling circuit including the first cooling line extending from the cooler through the first insulated carrier to the beverage supply and a first return line extending from the beverage supply through the first insulated carrier to the cooler.

5. A beverage dispense system according to claim 2 wherein the second cooling line forms part of a second cooling circuit, the second cooling circuit including the second cooling line extending from the cooler through the second insulated carrier to the dispensing site and a second return line extending from the dispensing site through the second insulated carrier to the cooler.

6. A beverage dispense system according to claim 1 further comprising a gas line connectable to a gas supply wherein the gas supply line is at least partly enclosed within the first insulated carrier.

7. A connector for use in a beverage dispense system for connecting a beverage line to a beverage supply, the connector comprising a sensor for sensing bubbles within the beverage line and for generating a signal for closing the beverage line when a predetermined level of bubbles is detected.

8. A connector according to claim 7 wherein the connector is connectable to a standard keg coupler.

9. A connector according to claim 7 wherein the sensor an optical sensor having an optical transmitter and an optical receiver.

10. A connector according to claim 7 further comprising cooling means for cooling the beverage line within the connector.

11. A connector according to claim 10 wherein the cooling means comprises a connector cooling circuit comprising a connector cooling line and a connector cooling return line for carrying chilled cooling medium, the cooling lines being in heat exchange relationship with the beverage line.

12. A connector according to claim 7 further comprising an indicator for providing an indication when the sensor has generated a signal for closing the beverage line.

13. A connector according to claim 7 further comprising a re-set actuator operable to generate a signal to re-open the beverage line.

14. A bubble detection system for use in a beverage dispense system, the bubble detection system comprising: a connector for connecting a beverage line to a beverage supply, the connector comprising a sensor for sensing bubbles within the beverage line and for generating a signal for closing the beverage line when a predetermined level of bubbles is detected; and a valve operable to close the beverage line upon receipt of the signal from the sensor.

15. A bubble detection system according to claim 14 wherein the sensor is an optical sensor having an optical transmitter and an optical receiver.

16. A bubble detection system according to claim 14 further comprising a connector cooling circuit for cooling the beverage line within the connector, the connector cooling circuit comprising a connector cooling line and a connector cooling return line for carrying chilled cooling medium, the cooling lines being in heat exchange relationship with the beverage line.

17. A bubble detection system according to claim 14 further comprising an indicator for providing an indication when the sensor has generated a signal for closing the beverage line.

18. A bubble detection system according to claim 14 further comprising a re-set actuator operable to generate a signal to re-open the beverage line

19. A bubble detection system according to claim 14 wherein the valve is a two-way valve.

20. A bubble detection system according to claim 14 further comprising an electronic control unit for receiving the signal from the sensor and, in response to the signal from the sensor, sending a signal to the valve to close the beverage line.

21. A method of replacing a beverage supply in a beverage dispense system having a beverage line having a distal end connected to the beverage supply for transporting beverage from a beverage supply site to a dispensing site, the method comprising providing a connector according claim 7 at the distal end of the beverage line, sensing a predetermined level of bubbles in the beverage line using the sensor, generating a signal to close the beverage line, detaching the connector from the beverage supply and affixing the connector to a second beverage supply.

22. Method according to claim 21 further comprising providing a visible indication when the sensor has generated a signal for closing the beverage line.

23. Method according to claim 21 further comprising providing a re-set actuator and actuating the re-set actuator to generate a signal to re-open the beverage line once the connector has been connected to the second beverage supply.

24. A beverage dispense system comprising a beverage line connectable to a beverage supply for transporting beverage from the beverage supply to a dispensing site and a connector according to claim 7.

25. A beverage dispense system comprising a beverage line connectable to a beverage supply for transporting beverage from the beverage supply to a dispensing site and a bubble detection system according to claim 14.

26. A beverage dispense system comprising: a beverage line having a distal end connectable to a beverage supply for transporting beverage from a beverage supply site to a dispensing site; the system further comprising a manifold through which the beverage line passes, wherein the length of beverage line between the distal end and the manifold is selected such that, when the manifold is mounted on the wall or ceiling of the beverage supply site, the distal end of the beverage line does not contact the floor of the beverage supply site.

27. A beverage dispense system according to claim 26 further comprising a connector according to claim 7.

28. A beverage dispense system comprising:
a beverage line having a distal end connectable to a beverage supply for transporting beverage from a beverage supply site to a dispensing site;
a manifold through which the beverage line passes, wherein the length of beverage line between the distal end and the manifold is selected such that, when the manifold is mounted on the wall or ceiling of the beverage supply site, the distal end of the beverage line does not contact the floor of the beverage supply site; and
a bubble detection system comprising:
a connector for connecting the beverage line to the beverage supply, the connector comprising a sensor for sensing bubbles within the beverage line and for generating a signal for closing the beverage line when a predetermined level of bubbles is detected; and
a valve operable to close the beverage line upon receipt of the signal from the sensor.

29. A beverage dispense system according to claim 1 wherein the system further comprises a manifold through which the beverage line passes, wherein the length of beverage line between the distal end and the manifold is selected such that, when the manifold is mounted on the wall or ceiling of a beverage supply site, the distal end of the beverage line does not contact the floor of the beverage supply site.

30. A method of installing a beverage dispense system comprising:
providing a beverage line having a distal end connectable to a beverage supply for transporting beverage from a beverage supply site to a dispensing site; providing a manifold through which the beverage line passes, mounting the manifold on the wall or the ceiling of the beverage supply site wherein the method further comprises selecting a length of beverage line between the distal end and the manifold is such that, when the manifold is mounted on the wall or ceiling of the beverage supply site, the distal end of the beverage line does not contact the floor of the beverage supply site.

31. A cooler for cooling beverage in a beverage dispense system wherein the cooler has a casing having a slanted top surface.
